(19) United States
(12) Patent Application Publication
(10) Pub. No.: US 2005/0263590 A1
(43) Pub. Date: Dec. 1, 2005

(54) Point of sale terminal having integrated customer and operator interfaces

(76) Inventors: James Branck, Frankfort, NY (US); Brian Johnson, Ilion, NY (US)

Correspondence Address: BOND, SCHOENECK & KING, PLLC, ONE LINCOLN CENTER, SYRACUSE, NY, 13202-1355, US

(21) Appl. No.: 11/049,921

(22) Filed: Feb. 3, 2005

Related U.S. Application Data
(60) Provisional application No. 60/541,430, filed on Feb. 3, 2004.

(51) Int. Cl. G06K 15/00

(52) U.S. Cl. 235/383

(57) ABSTRACT

The present invention provides an integrated point of sale transaction terminal that includes both operator and customer interfaces. A housing for the electronics of the point of sale terminal comprises an operator interface unit integrally associated therewith and extending from one side thereof and a customer interface unit integrally associated therewith and extending from the opposing side thereof.

### CROSS REFERENCE TO RELATED APPLICATION

The present application claims priority to Applicant's U.S. Provisional Patent Application, Ser. No. 60/541,430, filed Feb. 3, 2004, and Applicant's co-pending U.S. Design patent application, Ser. No. 29/213,764 filed Sep. 20, 2004.

### BACKGROUND OF THE INVENTION

1. Field of Invention

The present invention relates generally to point of sale terminals, and more particularly to point of sale terminals having both operator and customer interfaces.

2. Description of Prior Art

Point of sale systems typically comprise a transaction terminal, such as a cash register, keyboard, video display, printer, credit card reader, bar code scanner. The systems are typically networked to a central computer system that contains databases of such things as price lists, inventory management, and other back office type functions. In use, a consumer making a purchase presents the goods to an operator of the point of sale terminal, and the operator processes the sales transaction by scanning, keying in, or other manner of entering the product information into the system. The system then processes the data and displays price information on a monitor that is typically visible to both the operator and the consumer. The consumer then pays for the goods using either a credit/debit card, a personal check, or with cash or a cash equivalent (such as a gift certificate, traveler's check, or the like). In a typical system, the operator of the point of sale terminal takes the payment means from the customer and process the payment, returning any of the customer's property, such as the credit/debit card or change from a cash transaction once the transaction is complete. Such systems are functional, but often slow because the operator of the system needs to conduct all of the processing.

More recently, separate consumer interface units have become available. For instance, a credit/debit card reader is conveniently positioned in front of a consumer who may process his/her own credit card prior to the goods all being processed by the operator. The consumer interface is a stand alone unit that is electronically tethered to the operator terminal, and may include a video display for the consumer, as well as other functional attributes, such as the card reader. Once the goods are all processed, the credit card has already been verified and a receipt for the customer to sign is printed, or an electronic signature might be available on the customer interface unit. Hence, the payment process is conducted in a more expeditious manner than with the traditional transaction.

Such consumer and operator terminals are functional in a check out system whereby aisles of customers progress through the check-out, such as is typical in grocery stores. However, because of the space constraints associated with the separate consumer interface unit, these types of systems are less attractive for commercial operations where consumers stand in adjacent lines to progress through the check-out process, such as is typical with fast food restaurants where many point of sale terminals will be arranged in close, side by side relation.

3. Objects and Advantages

It is therefore a principal object and advantage of the present invention to provide a point of sale transaction terminal that includes both a customer interface and an operator interface in an integrated package.

Other objects and advantages of the present invention will in part be obvious, and in part appear hereinafter.

### SUMMARY OF THE INVENTION

In accordance with the foregoing objects and advantages, the present invention provides an integrated point of sale transaction terminal that includes both operator and consumer interfaces. A housing for the electronics of the point of sale terminal comprises an operator interface unit integrally associated therewith and extending from one side thereof and a customer interface unit integrally associated therewith and extending from the opposing side thereof. The electronics to drive both the customer interface unit and the operator interface unit are contained on an integrated circuit board that is contained within the housing.

The operator interface unit comprises a visual display and a touch screen having typical function keys, an operator credit/debit card reader, a fingerprint reader, and an IR bar code scanner. The customer interface unit comprises a video display and touch screen having typical functional keys incorporated thereon, a customer credit/debit magnetic card reader, a customer PIN number pad, and audio speakers. The main processor is electronically coupled to the components of the interface units in traditional fashion. The main processor may contain a predetermined amount of hard disk memory, or other non-volatile memory, and will be powered in a conventional manner. Instead of having a hard drive, the application could be downloaded during the system power on self test (POST) and boot sequence, and data generated could be saved to a server. The terminal may further be equipped with additional ports to permit upgrading and/or enhancing of the terminal's features. For instance, additional parallel and USB ports, PS/2 connections for a mouse and keyboard, network interface connections, PCI expansion slots and additional RS-232 slots.

### BRIEF DESCRIPTION OF THE DRAWINGS

The present invention will be more fully understood and appreciated by reading the following Detailed Description in conjunction with the accompanying drawings, in which:

FIG. 1 is a user side perspective view of my new design for a point of sale display having integral customer and operator interfaces;

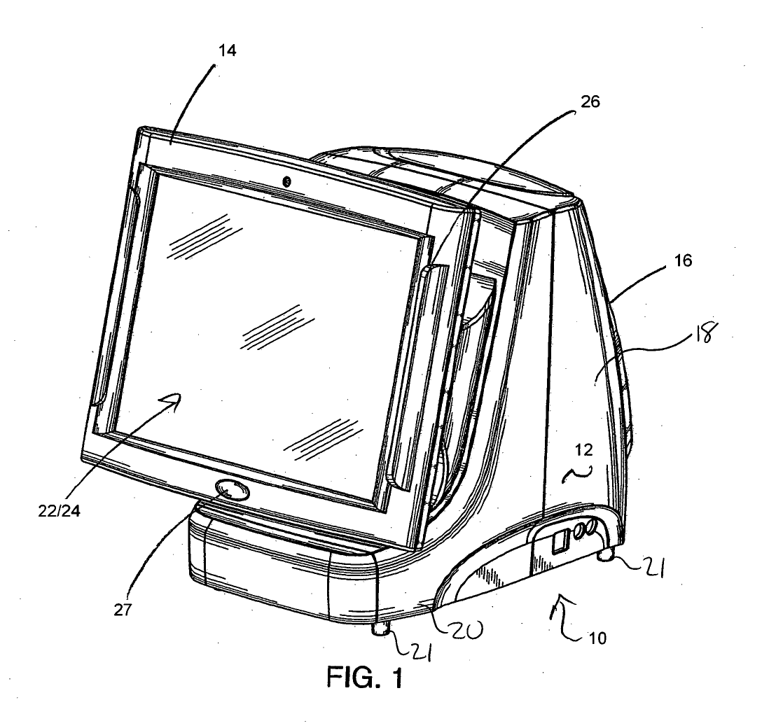

FIG. 2 is a customer side perspective view thereof;

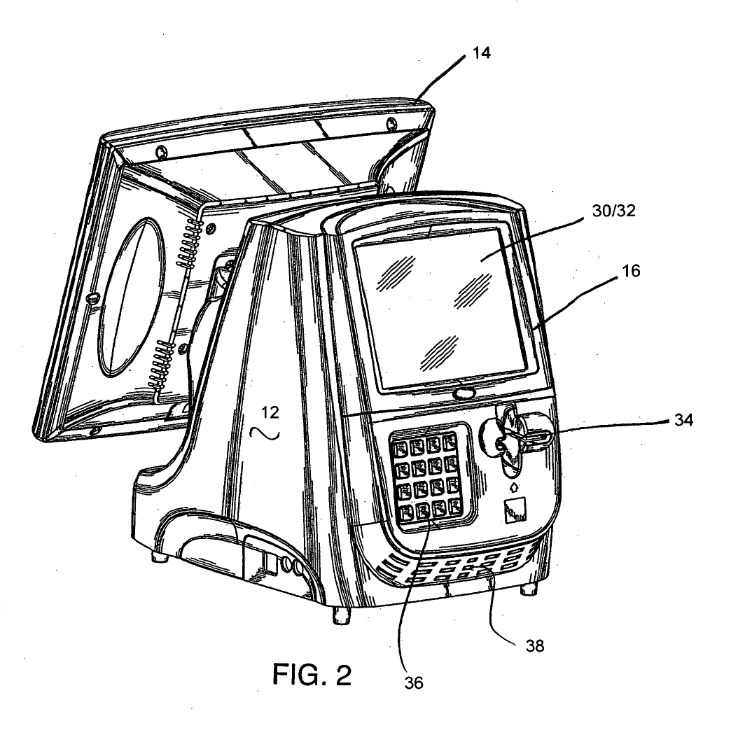

FIG. 3 is an elevation view of the operator interface side of thereof;

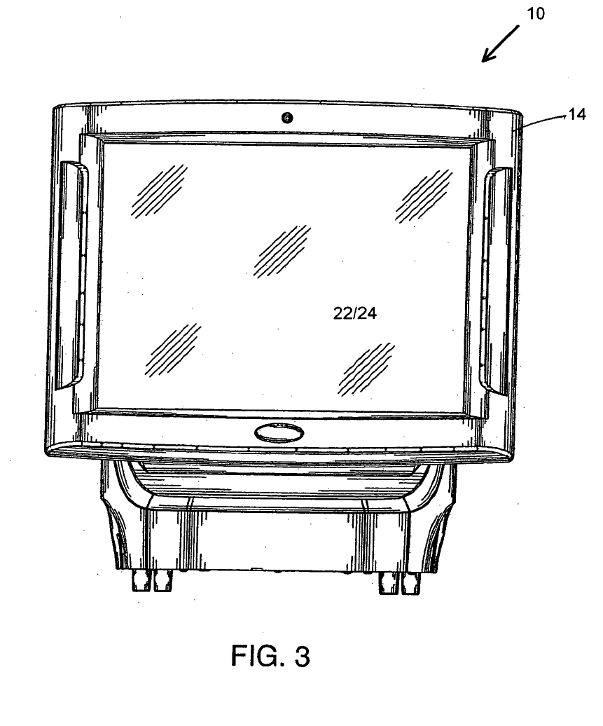

FIG. 4 is an elevation view of the customer interface side thereof;

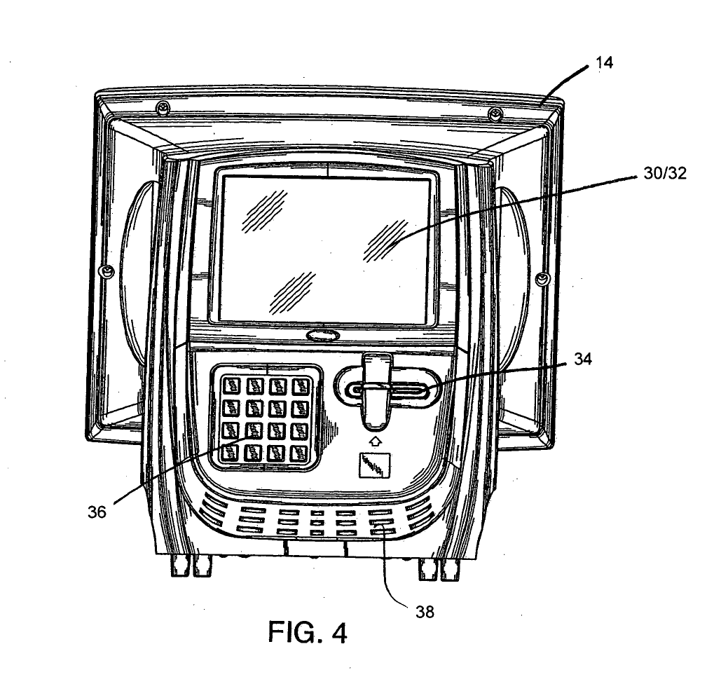

FIG. 5 is a first side elevation view thereof;

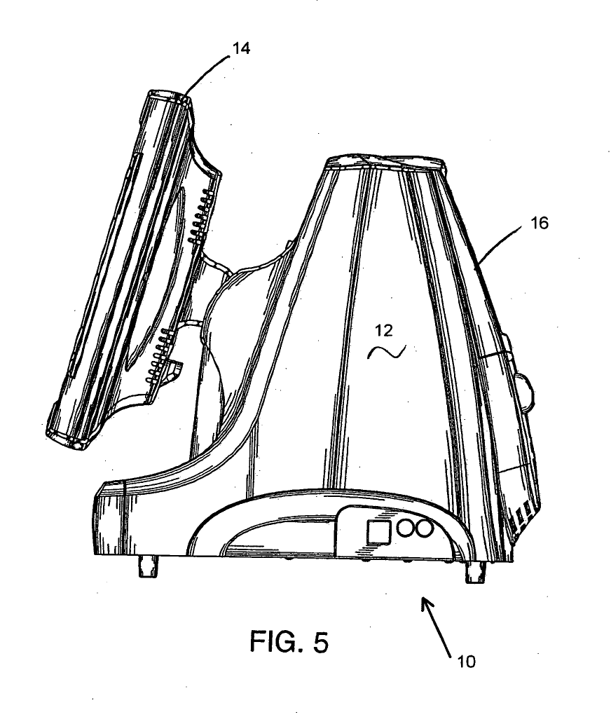

FIG. 6 is a second side elevation view thereof;

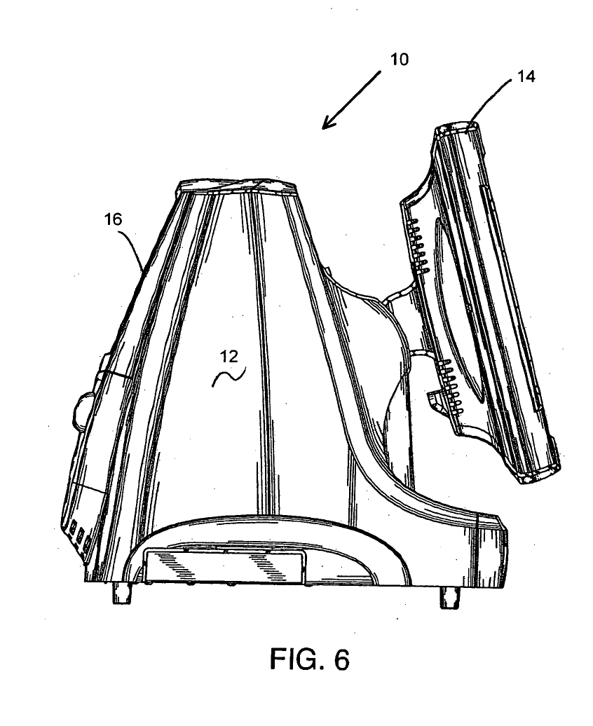

FIG. 7 is a top plan view thereof;

FIG. 8 is a bottom plan view thereof; and

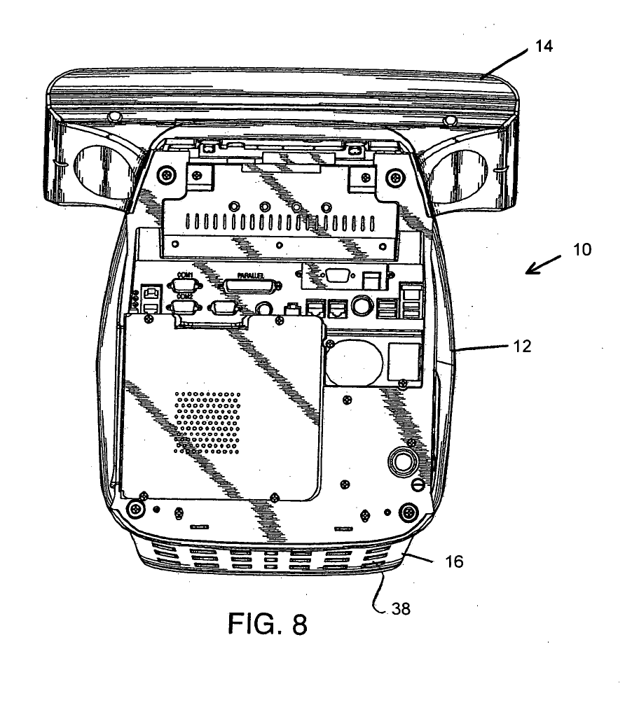

FIG. 9 is a high level block diagram of the electronic configuration of the point of sale terminal.

### DETAILED DESCRIPTION

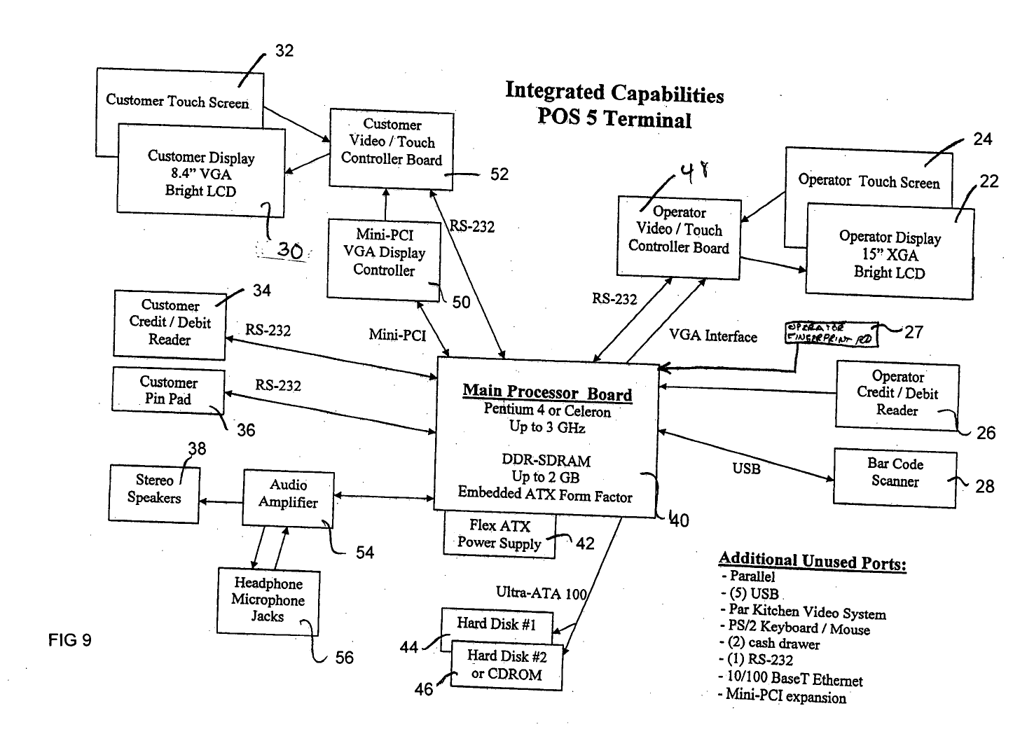

Referring now to the drawings, wherein like reference numerals refer to like parts throughout, there is seen in the Figures a point of sale terminal, designated generally by reference numeral 10, comprising a housing 12, an operator interface unit 14 integrally associated with and positioned on one side of the housing, and a customer interface unit 16 integrally associated with and positioned on the opposing side of the housing. Housing 12 securely contains a circuit board, the high level details of which are shown in FIG. 9 and which will be described hereinafter. Operator interface unit 14 and customer interface unit 16 are each mounted to housing 12 in a manner that creates a unitary point of sale terminal (the term “integrally associated with” used herein refers to this unitary construct of point of sale terminal 10, and not necessarily the traditional, dictionary definition of “integral” where all components may be molded or otherwise constructed in a single piece).

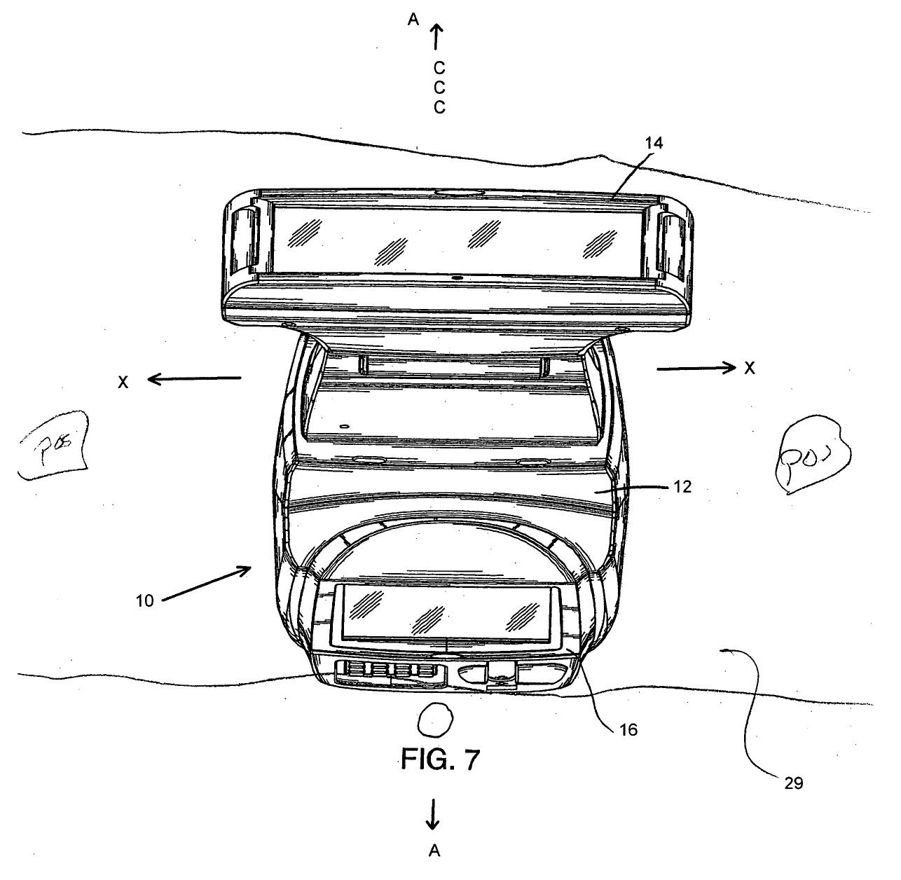

Housing 12 includes a body 18 and a base 20, which may include soft pads 21 to prevent scratching of the surface on which it is adapted to rest, such as a countertop, and is preferably molded from PVC. Operator interface unit 14 is mounted to one side surface of housing 12, and may be integrally molded therewith. Preferably, operator interface unit 14 will be ergonomically tilted upwardly relative to an operator who would be standing in front of it, and may be pivotally moved about axis X-X (see FIG. 7) relative to housing body 18 to assist in this regard. Customer interface unit 16 is mounted to the opposing side surface of housing body 18 and is also ergonomically tilted upwardly relative to a customer who would be standing in front of it.

Operator interface unit 14 includes a video monitor 22 and a touch screen 24 containing traditional transactional keys for the particular business using the terminal, such as “large soda,” numeric keys, calculator functions, and the like, all of which are well known and understood in the art, mounted thereon. In addition, operator interface unit 14 may further incorporate a credit/debit card magnetic strip reader 26 (see FIG. 9), fingerprint reader 27 which can control access to confidential items on the system and/or assist in logging in and out of operators, and bar code scanner 28 (see FIG. 9).

In operation, point of sale device 10 is adapted for placement on a counter 29 in adjacent relation to numerous other point of sale devices of similar construct as is the traditional point of sale set-up in the fast food restaurant industry. An operator “O” is positioned on one side of the counter facing operator interface unit 14, while a row of customers each designated “C” in FIG. 7 form a line that extends along longitudinal axis A-A with operator O and point of sale device 10 also being on this same axis. The customer C closest to counter 29 is facing customer interface unit 16 and can physically interact with the display that forms a part of the customer interface, while the remaining customers stand in line behind the first customer and await their turn in placing their orders. The operator, O, meanwhile, can physically interact with the operator interface unit 14 in the necessary manner to complete the point of sale transaction. By offering customers the ability to physically interact with the point of sale device 10, it is believed that the point of sale transaction will become more efficient than the current state of the art makes possible, and additional sales and marketing options can be made available to the customers.

Customer interface unit 16 includes a video monitor 30, a touch screen 32 containing at least a key pad and other functional buttons, such as “credit,” “debit,” “check,” and “cash” buttons, a customer credit/debit card reader 34, a PIN keypad 36, and speakers 38.

Point of sale terminal 10 includes a circuit board with a main processor 40, such as a PENTIUM® 4 or CELERON®, with sufficient RAM, which may be in the form of DDR-SDRAM with an embedded ATX form factor, mounted thereon. Power is supplied to main processor 40 via a standard power supply 42, such as Flex ATX power supply. Hard disk space 44 and/or CD-ROM 46 is electrically connected to main processor 40, via an Ultra-ATA 100 in the preferred embodiment. It should be understood that the application could be downloaded during the system power on self test (POST) and boot sequence, and data generated could be saved to a server, thereby alleviating the need for hard disk space 44. Main processor 40 is further electrically connected to operator video/touch screen controller 48 via a standard RS-232 protocol and VGA interface, which in turn, is connected to operator touch screen 24 and display 22, to operator credit/debit card reader 26, bar code scanner 28, customer pin pad 38, customer credit/debit card reader 34, and a mini-PCI VGA controller 50 and customer video/touch screen controller board 52 (to which mini-PCI VGA controller 50 electrically sends communications) which in turn communicates with customer touch screen 32 and customer display 34. Main processor 40 is further electrically connected to an audio amplifier 54 which, in turn, communicates with speakers 38 and microphone headphone jacks 56. The wired connections that make the aformentioned interconnections are all housed within housing 12 and remain invisible to users of terminal 10.

A preferred embodiment of the present invention has been described herein. However, it is understood that various modifications could be made to the preferred embodiment while not departing from the full scope and spirit of the present invention which is defined in the appended claims.

1) A point of sale transaction terminal for use in a point of sale environment in which customers form a line that extends along a longitudinal axis in which the terminal itself and an operator of the terminal are also positioned, comprising:
a) a housing having first and second opposite sides interconnected by sidewalls extending therebetween, and storing a processing unit therein;
b) an operator interface unit positioned on said first side of said housing and that is in communication with said processing unit and is adapted for physical interaction with the operator; and
c) a customer interface unit positioned on said second side of said housing and in communication with said processing unit and adapted for physical interaction with a first customer.

2) The point of sale terminal of claim 1, wherein said operator interface unit includes a video monitor.

3) The point of sale terminal of claim 1, wherein said operator interface includes a touch screen adapted for engagement by the operator;

4) The point of sale terminal of claim 1, wherein said operator interface unit includes a security device incorporated therein;

5) The point of sale terminal of claim 4, wherein said security system is a biometric reader.

6) The point of sale terminal of claim 5, wherein said security system is a fingerprint reader.

7) The point of sale terminal of claim 1, wherein said customer interface unit includes a video monitor.

8) The point of sale terminal of claim 1, wherein said customer interface unit includes a touch screen adapted for engagement by a customer.

9) The point of sale terminal of claim 1, wherein said customer interface unit includes a magnetic stripe reader incorporated therein.

10) The point of sale terminal of claim 1, wherein said customer interface unit includes speakers mounted therein.
